(19) United States
(12) Patent Application Publication
(10) Pub. No.: US 2007/0219865 A1
(43) Pub. Date: Sep. 20, 2007

(54) Method and System for Collecting, Tracking and Reporting Consumer Data to Improve Marketing Practices for Merchants and Banks

(76) Inventor: Adam C. Leining, San Francisco, CA (US)

Correspondence Address: KIRTON AND MCCONKIE, 60 EAST SOUTH TEMPLE,, SUITE 1800, SALT LAKE CITY, UT, 84111, US

(21) Appl. No.: 11/562,191

(22) Filed: Nov. 21, 2006

Related U.S. Application Data
(60) Provisional application No. 60/739,459, filed on Nov. 23, 2005.

(51) Int. Cl. G06Q 30/00

(52) U.S. Cl. 705/14

(57) ABSTRACT

A method and system for improving marketing practices for merchants and banks, the method and system comprising advertising via a commercial offer solicited to a consumer, wherein upon noticing the commercial offer, the consumer is directed to a website for a facilitator; collecting data from the consumer at a website, wherein the data contains the consumer's personally identifiable information and purchasing preferences and needs; using the data to enable the facilitator to formulate a focused marketing plan based on the consumer's needs and preferences; and compensating the facilitator based on purchases made by the consumer resulting from said facilitator's focused marketing plan.

### 1. RELATED APPLICATIONS

This application claims priority to U.S. Provisional Application Ser. No. 60/739,459 filed Nov. 23, 2005, entitled “Method and System for Collecting, Tracking and Reporting Consumer Data to Improve Marketing Practices for Merchants and Banks”.

### BACKGROUND

1. Field of Invention

The present invention relates to a method and system for collecting, tracking and reporting consumer data to improve marketing practices for merchants and banks. More particularly, the present invention entails a method and system for collecting data via a consumer card and from that data, tracking a consumer's purchasing history. The customer's purchasing history, which relays the customer's needs and preferences, may then be used to: compensate a marketing service provider on a “fee-for-results” basis; assess whether or not a particular marketing practice was effective; and/or assist in tailoring marketing activities for a merchant based on the collected data.

2. Background and Related Art

Successful marketing is integral to gaining customer patronage and loyalty. A successful marketing plan requires merchants to identify target customers, advertise and promote their product or services to those customers, and gain customer loyalty through customer patronage. For this reason merchants or service providers (hereinafter “merchants” for simplicity) retain competent marketing and advertising firms to increase profit margins. Moreover, such investments in advertising generally yield solid returns. That is, a merchant's investment in a strong advertising campaign potentially yields a higher profit margin for the merchant than is achievable without such a campaign.

Unfortunately, there are drawbacks with traditional advertising methods. First, current methods of advertising impose high initial costs on merchants and second, with traditional techniques it is difficult for a merchant to determine the amount he or she should spend on advertising. For instance, with respect to the latter, merchants generally approximate the amount to spend for marketing by using the industry standard of investing “five-percent of the previous year's revenue” for advertising in the subsequent year. Depending on the merchant's product, this percentage may be more or less. The merchant must decide if increasing or decreasing the percentage would result in increased or decreased sales. The merchant must also make decisions, such as whether or not mass media advertising, though expensive, is worthwhile. Finally, to measure effectiveness of advertising, the merchant must determine the amount of sales that would have occurred without doing anything. The foregoing decisions can be complicated.

The merchant must also evaluate whether or not a particular advertising campaign was effective. This is also difficult to determine. For instance, in evaluating the success of a marketing strategy, it is difficult to assess how spontaneous sales, by customers who were attracted to the merchant's goods by an advertisement for something other than that which they purchased, should be measured. As such, whether or not an investment on advertising yields positive results is difficult to quantify.

Moreover, though many forms of advertising are inexpensive, they also have shortcomings. For instance, though advertising by e-mail is inexpensive, unsolicited email is burdensome to networks and tends to irritate consumers. E-mail advertisements are also frequently filtered. Because of this, reputable merchants tend to abstain from email advertising and instead, send e-mail advertisements and offers only to consenting customers. Alternatively, advertising on a website is also inexpensive. However, website advertising is competitive and exposure of an ad depends on popular browsers actually “finding” the ad and customers opening it.

Another good way to advertise is by gathering and assessing a consumer's purchasing history, and using that history to customize a marketing practice based on the consumers' needs and preferences. These types of methods of targeting consumers based on the customer's preferences and needs are disclosed in Scroggie, et al., U.S. Pat. No. 6,014,634 and Peirce, et al., U.S. Pat. No. 6,332,126. However, one drawback is that evaluating a customer's purchasing history is not only difficult to generalize, but also to automate. For instance, a customer's purchasing history involves the customer's purchase of both consumables and durables. However, consumables and durables require diametric advertising techniques, so generalization about a marketing practice based on a consumer's purchasing history is difficult. Neither Scroggie nor Peirce discloses targeting consumers based on their history of purchasing travel, hospitality, or services in general. Thus, there is a need in the art for an improved method and system for using a customer's purchasing history to create an effective and focused marketing plan.

Another way to advertise involves a merchant offering preferential discounts to members of organizations. For example, merchants may offer discounts to motorists, seniors, professionals, or travelers. This method helps the merchant determine the effectiveness of an ad campaign because such preferential discounts include rate codes that the consumer gives to the merchant in order to receive the discount, and by this, the merchant assesses how many consumers were affected by a particular ad campaign.

Merchants also market by using consumer cards. Specifically, merchants can encourage consumers to return to a merchant by using charge cards, loyalty cards and collaborative credit cards offered by merchant and a collaborating bank, where special discounts are offered to consumers using their cards. An internal card, such as a gas card may combine an optional credit privilege from a collaborating bank, making it acceptable by other merchants. Examples of these collaborative credit cards are REI®/Visa (or Costco®/American Express®. A merchant may use these consumer cards as a means of advertising because when the consumer applies for the card, or when he or she discloses information about his or her geographical area, age, and interests (if on application). Moreover, the application can provide a place where the consumer consents to receive commercial e-mail from the merchant. One draw back of this marketing practice is that even though customers consent to receive email ads, spam filters still may divert approximately ten percent of consensual, commercial e-mail.

A need, therefore, exists for merchants to effectively advertise to consumers in a cost-effective, focused and efficient manner, and to create an advertising campaign based on consumers' needs and preferences so that merchants' investment in advertising yields an optimal return. A need also exists for the ability of a merchant to assess whether or not the advertising campaign was successful based on the consumers' purchasing history.

### SUMMARY OF THE INVENTION

Some embodiments provide a method of collecting data of consumers' purchasing preferences and needs, and using that data: to formulate optimal marketing methods for a merchant; assess whether or not a previously practiced advertising technique worked; compensate the marketing service provider according to the success of the advertising technique; and/or accomplish the foregoing by use of a consumer card.

Some embodiments involve: a merchant; a facilitator; and a collaborating bank, all of which may pay attention to data collected from a consumer's use of a consumer card, which is maintained by a facilitator and a merchant.

Some embodiments, a facilitator creates an agreement with a merchant to deliver advertising services. Facilitator then distributes merchant's advertisement in the form of a commercial offer to potential consumers via facilitator's website, e-mail, and media. A consumer notices the commercial offer and is directed to facilitator's website. At the website, if the consumer is not an already registered member of facilitator's services at the time he or she wishes to take advantage of the commercial offer, he or she may complete an online registration process on facilitator's website. By doing so, the consumer becomes a “member” entitled to special benefits and discounts of the merchant's goods (or services), and subsequently receives a consumer card reflecting such membership. The registration process gives the consumer the option to consent to having his or her consumer card serve simultaneously as a debit or credit card (i.e., payment card). For this to happen, consumer's application must first be approved by a collaborating bank.

In this preferred embodiment, during the registration process, the consumer voluntarily provides information about his or herself, such as geographic location of residence, age, preferences of products and services, needs of products and services, and consent to receive future commercial offers, mailings and advertisements from merchant and facilitator. The information may be used to create a database containing data of the personal information the consumer consensually provided about his or herself.

In some embodiments, data may then be used to formulate a focused marketing plan, based on consumer's needs and preferences so that redundant, inefficient advertising by merchant is avoided. In some embodiments, facilitator collects data about the needs and preferences of the consumer and also has the permission of the consumer to commercially advertise by email to the consumer. As a result, the facilitator has enough information to recommend to the merchant the types of products (or services) most likely to attract the consumer to the store and to make purchases. Moreover, this data also indicates the most effective method of contacting, marketing and advertising to the consumer.

In some embodiments, data maybe used to compensate the facilitator. Based on data regarding the consumer's purchase history, and merchant's transaction history, the merchant may link purchases to specific advertising campaigns and commercial offers. As such, the facilitator may be compensated on a “fee-for-results” basis. That is, the facilitator may be compensated based on purchases made by the consumer stemming from the commercial offers and advertisements provided facilitators. After such a connection is made, facilitator may bill the merchant, daily, weekly or monthly, based on the sales tracked by the facilitator involving the commercial offer.

In some embodiments, the consumer may then use merchant's and facilitator's commercial offer by making a purchase either online or directly at merchant's store. If consumer takes advantage of commercial offer at merchant's store, the consumer would show the merchant the consumer card and perhaps a special discount code, to receive special benefits or discounts from merchant. Moreover, if the consumer chose to have the consumer card also serve as a credit or debit card (i.e., payment card), and the consumer's application for credit capabilities was accepted by the collaborating bank, the consumer would then pay for the product or service using the consumer card. So, if the consumer simply used the member card along with a special rate code, merchant would provide the consumer's information to the facilitator. Thus, the consumer card serves to both reflect a consumer's membership to a merchant and redeem a commercial offer, or to pay for the product or service with a separate payment card.

In some embodiments, consumer's preferences are acquired by the following: after the purchase transaction is completed, the collaborating bank, or a payment processor, delivers a copy of the purchase transaction record to the facilitator for analysis. Then in some embodiments, based on the consumer's purchase history, facilitator may then update its data records, including the consumer's account history and merchant's transaction history.

The foregoing entails the preferred embodiment of the present invention.

In some embodiments, the commercial offer is advertised through facilitator's website.

In other embodiments, filling out the application for converting the consumer card from serving as an ordinary membership and identification consumer card to a credit or debit card occurs during the same online session as when the consumer initially applies for the consumer card.

In other embodiments, the billing process by the facilitator to the merchant is conducted electronically.

In other embodiments the facilitator may issue the consumer a cash back incentive for the specified product or service advertised prior to the consumer's purchase. In some embodiments, payment to the consumer may be accomplished by issuing a credit to the consumer's debit or credit account held with the participating bank.

Some embodiments of the present invention provide a method and system for collecting consumer data via a consumer card, wherein the data collected identifies a consumer to a merchant, and is used to track and report the consumer's purchasing history to a facilitator. The facilitator then creates a marketing plan based on such data and is compensated if consumer makes purchases resulting from such a marketing plan.

These and other embodiments of the present invention will become more fully apparent from the following description, drawings, and claims. Other embodiments will likewise become apparent from the practice of the invention as set forth hereafter.

### BRIEF DESCRIPTION OF THE DRAWINGS

The foregoing and other features of the present invention will become more fully apparent from the accompanying drawings when considered in conjunction with the following description and appended claims. Although the drawings depict only typical embodiments of the invention and are thus, not to be deemed limiting of the invention's scope, the accompanying drawings help explain the invention in added detail.

FIG. 1 illustrates a representative computer device for use in association with at least some embodiments of the present invention;

FIG. 2 illustrates a representative computer network system for us in association with at least some embodiments of the present invention; and

FIGS. 3a and 3b depict a process diagram illustrating a non-limiting example of an embodiment of a method for collecting data via a consumer using a consumer card, and from that data, tracking a consumer's purchasing history so that the facilitator is compensated on a “fee-for-results” basis; is able to assess whether or not a particular marketing practice was effective; and can assist in tailoring marketing activities for a merchant based on the collected data.

### DETAILED DESCRIPTION OF THE INVENTION

It is emphasized that the present invention, as illustrated in the figures and description herein, can be embodied in other forms. Thus, neither the drawings nor the following more detailed description of the various embodiments of the system and method of the present invention limit the scope of the invention. The drawings and detailed description are merely representative of the particular embodiments of the invention; the substantive scope of the present invention is limited only by the appended claims. The various embodiments of the invention will best be understood by reference to the drawings, wherein like elements are designated by like alphanumeric character throughout.

### Exemplary Operating Environment

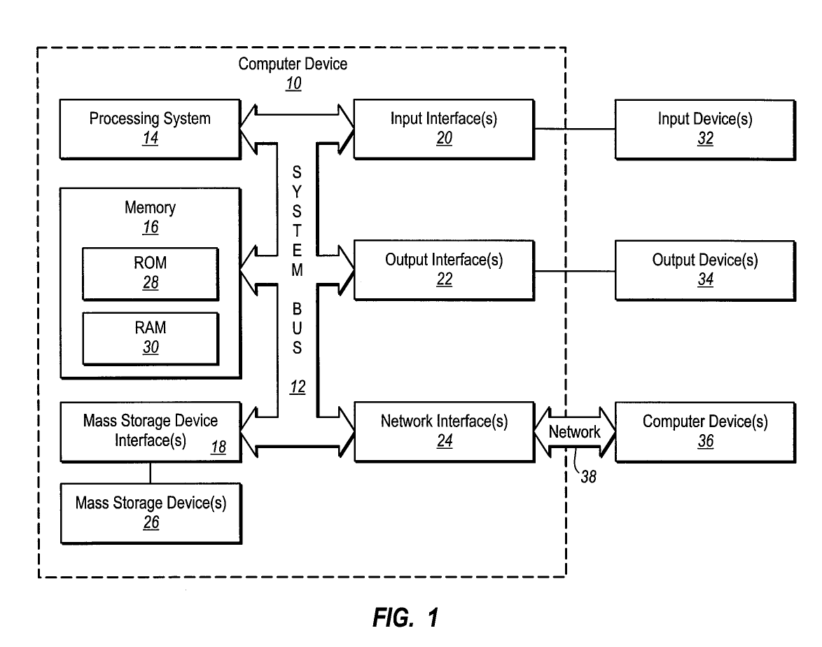

At least some embodiments of the present invention take place in association with one or more computer devices that are configured for utilization in association with providing an in-store media broadcast. Accordingly, FIG. 1 and the corresponding discussion are intended to provide a general description of a computer device. One skilled in the art will appreciate that the invention may be practiced by one or more computer devices and in a variety of configurations, including networked configurations.

Some embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, such as a receiver or other processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

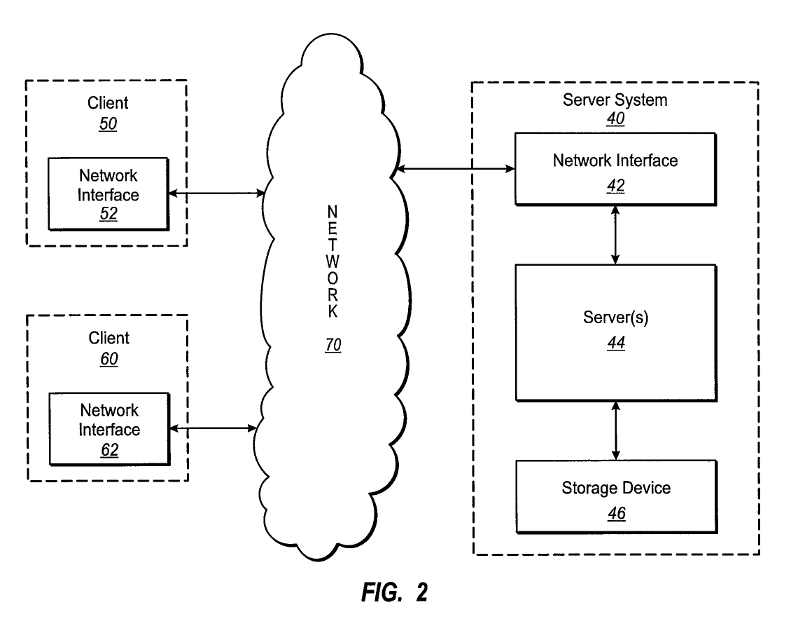

While those skilled in the art will appreciate that embodiments of the present invention may be practiced in a variety of computing environments with many types of computer system configurations, FIG. 2 provides a representative configuration that includes two clients connected to a server system. Those skilled in the art will appreciate that alternative embodiments include one client connected to a server system, more than two clients connected to a server system, a peer-to-peer system configuration, radio technology, satellite technology, a variety of computer media technology, and the like. Moreover, some embodiments in accordance with the present invention include a multitude of clients throughout the world connected to a network, where the network is a wide area network, such as the Internet.

As provided above, embodiments of the present invention take place in association with collecting data via a consumer using a consumer card, and from that data, tracking a consumer's purchasing history so that the facilitator to the foregoing process: is compensated on a “fee-for-results” basis; is able to assess whether or not a particular marketing practice was effective; and can assist in tailoring marketing activities for a merchant based on the collected data. A system, architecture or interface is used to transfer data related to consumer transactions between facilitation, banks, merchants and consumers. By way of example, a system configuration is illustrated in FIG. 2 that includes a clearinghouse or server system 40 connected to clients 50 and 60 via a network 70, wherein client refers to any third party transaction data with facilitator. Those skilled in the art will appreciate that network 70 may include a wide area network (e.g., the internet), a local area network, a leased line connection, a wireless network, a dial up connection, a satellite connection, a radio connection and/or any other type of connection that enables information to be exchanged between system 40 and clients 50 and 60.

System 40, client 50, and client 60 each include a network interface (respectively illustrated as network interfaces 42, 52, and 62) that enables information to be exchanged or communicated. In the illustrated embodiment, system 40 also includes one or more servers 44 that selectively manage data, which is preserved at and/or obtained from a storage device 46.

### Systems for Collecting and Utilizing Consumer Data

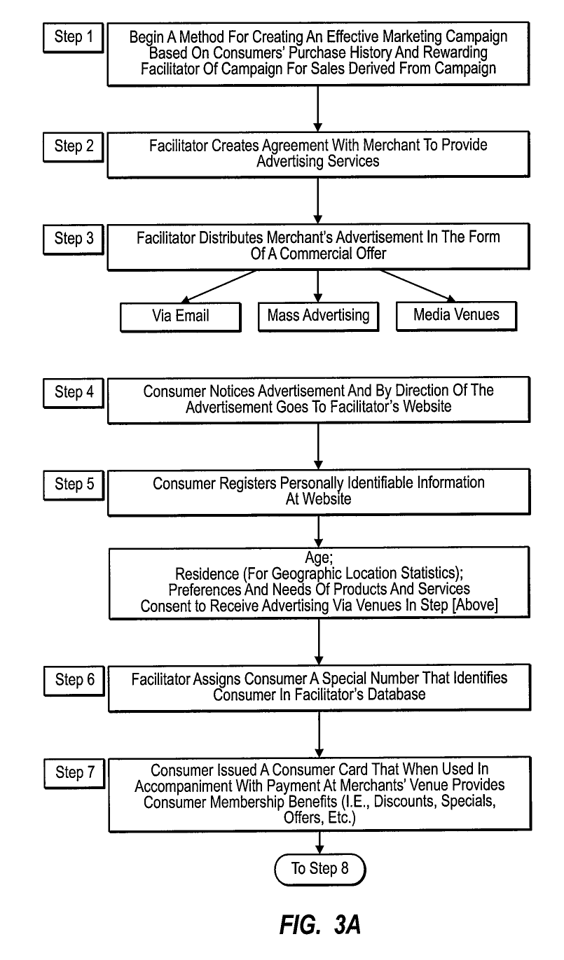

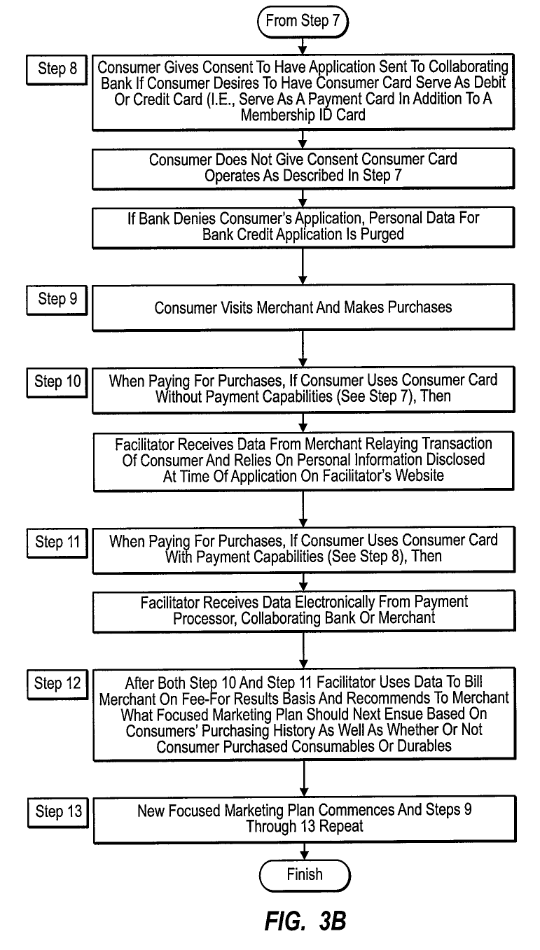

With reference now to the accompanying drawing, FIG. 3 depicts a non-limiting example of an embodiment of a process diagram 80 illustrating a method for collecting data via a consumer using a consumer card, and from that data, tracking a consumer's purchasing history so that the facilitator to the foregoing process: is compensated on a “fee-for-results” basis; is able to assess whether or not a particular marketing practice was effective; and can assist in tailoring marketing activities for a merchant based on the collected data.

Specifically, the facilitator may negotiate contracts with a merchant 82. The facilitator may also negotiate a contract with the bank. (Not depicted in FIG. 1.) The facilitator may negotiate consumer-friendly practices and privacy in these contracts. In a non-limiting example, the facilitator negotiates with the merchant on items such as favorably handling consumer returns or charge backs with merchant and the collaborating bank.

The facilitator may then advertise 84. Such advertising may involve using a commercial offer. The advertising may be done at facilitator's expense through channels such as email, mass advertising and media venues 86, though not limited to the foregoing. In some embodiments facilitator might use facilitator's and others' websites as a venue for advertising. The advertisements may solicit consumers to apply for a consumer card offered by merchant and facilitator, list the benefits of having such a card, wherein such benefits are provided by merchant, and direct the interested consumer to facilitator's website. Thus, consumer notices facilitator's and merchant's advertisement and visits facilitator's website 88. The facilitator's website may be open to all.

Consumer may then register his or her personally identifiable information at facilitator's website 90. Such information may include, but is not limited to, consumer's: age; geographic location (both for statistical purposes); preferences and needs of products and services; and consent to receive advertising via venues identified in Step 3 (92). As is common with many website enrollment pages, the information that is required of the consumer may be highlighted. A link to facilitator's privacy policy may also be made available.

The consumer may also agree to other conditions at the time of enrollment on facilitator's website. In a non-limiting example, the consumer consents to periodically reply to test messages from the facilitator to ensure that consumer is receiving advertisements from facilitator and merchant. The consumer may also specify whether or not his or her membership card will be shared within consumer's immediate family. The consumer also may declare the correctness of the information and attest that to the best of his or her knowledge. This type of information may be helpful in if the bank extends credit.

The facilitator may process consumer's application, review it and assigns a special number that identifies consumer in facilitator's database 94. At some point, after the application is filled out by consumer, facilitator may issue consumer a card that when used in accompaniment with a form of payment at the merchant's venue, provides the consumer with membership benefits, such as discounts, specials, offers, etc 96.

While filling out the application relaying consumer's personal information, consumer may also consent to have his or her information forwarded to a collaborating bank that would extend consumer a debit or credit capability for the consumer card 38, thus transforming it from a membership card into a payment card. In this context, the facilitator is not required to certify the truth of consumer's application or creditworthiness. Rather, the facilitator simply retains the personal data and forwards a copy to the collaborating bank. Alternatively, the bank may conduct its own credit application directly with the consumer who was referred to the bank by the facilitator. The consumer may also consent that the bank share his or her purchasing history with the facilitator since the bank will have access to the purchasing history by the consumer making a payment using the consumer/payment card. The foregoing enables the facilitator's ability to focus a marketing plan and be compensated based on a consumer acting because of the plan.

The consumer card may have various characteristics. For instance, the consumer card may be called a membership card, a preference card, a loyalty card, a discount card, a rewards card, a premium card, a frequent-flyer card, etc. The card may also carry the logo of more than one merchant, as well as the collaborating bank.

The facilitator may generate, update, and maintain the database of members. The database may be searchable by numbers assigned to consumer upon application, other numbers, keywords, postal code, and from data collaborated with the bank. Moreover, the facilitator may assume responsibility for the process of managing communication between the collaborating banks, merchants, and consumers. In a non-limiting example, the facilitator is responsible for providing, maintaining and securing computer software and channels of communication with interfaces and protocols specified by participating merchants and banks, which are outside of those routinely used by the merchant and the bank to process credit or debit transactions.

In some embodiments, the facilitator approves the focused marketing plain (i.e., the advertising campaign's goals, message, approach, timeline and budget) and negotiates its compensation from sales with the merchant. To create the focused marketing plan, the facilitator may select consumers to receive the merchant's advertising based on the goods and services offered from the information on consumer's applications at time of enrollment, and from the consumers' stated preferences at time of enrollment. Or, selection could be made based on a consumer's purchasing history provided by data collected from the consumer card when it serves as a payment card.

In some embodiments, to formulate and continue focused marketing plans, the facilitator creates and maintains a database of the merchant's current graphic art and advertising messages. The facilitator composes effective email ads that link to websites, which optimally are of limited risk to the consumer, and which also avoid spam filters and account for slow modems. The facilitator then uses the database to advertise only appropriate offers to selected consumers. That is, facilitator decides the most optimal way to target certain consumers whether it is mass media, special-interest media, direct mail, selective and consensual email, or by posting the advertisement on the website of the facilitator or merchant. The advertisement may include a rate code that would help merchant link purchase to facilitator's advertising.

In some embodiments, the facilitator maintains the integrity of the process. In a non-limiting example the facilitator may cancel a consumer's membership in the situation where the consumer is abusing the card, or where there has been no purchase for a pre-determined number of months or at consumer's request. In some embodiments, within thirty days of cancellation, the facilitator notifies the ex-member consumer and purges their information from the database.

In some embodiments, the facilitator earns commission from merchant for sales connected to the facilitator's advertising activities or focused marketing plan and linked by identifying consumer's card number, rate code, product or service code, geographical area, or date presented to merchant at the time or purchase. Facilitator may also receive a fee from the collaborating bank for each new account the facilitator brings to the bank.

In some embodiments and illustrated in FIG. 1, the consumer may sign a membership consumer card upon receiving it from facilitator. The consumer may then visit the merchant and make purchases 100. When paying for purchases, if consumer uses consumer card without payment capabilities 102 then the consumer presents the consumer card to take advantage of member benefits and the merchant identifies the consumer and forwards the foregoing transaction to the facilitator for recording in the database. The consumer may present the consumer card along with an optional rate code, if such accompanies a special offer, and the consumer may request any applicable discounts or privileges as advertised. When paying for the purchase, if the consumer uses the consumer card as a payment card 104, then facilitator goes through the bank, a payment processor or the merchant to acquire and record the transaction and track subsequent transactions.

The process may repeat itself 48 such that after the consumer makes a purchase either using the consumer card as a payment card, or using it merely as a membership identification consumer card, the data from the transaction is sent by the merchant or bank to the facilitator, which then analyzes the data. The facilitator then bills the merchant for successfully motivating a purchase based on facilitator's marketing plan, and proceeds to formulate a new marketing focus for the consumer based on such transactions 106.

Though not represented in the figure, the following also provides details inherent in the foregoing process.

The Role of Banks and Payment Processors

In some embodiments, the bank may qualify the consumer for an optional credit or debit card. In a non-limiting example, the bank does not request from facilitator the consumer's credit report without his or her permission. If requested by consumer, the bank may create a debit or credit card account for the qualifying consumer and share purchase transaction data with the facilitator. In some instances, the collaborating bank or facilitator may request purchase transaction data from an electronic payment processor.

The bank may compensate the facilitator for bringing in new accounts. In a non-limiting example, compensation is a fee for each new account. The facilitator may also proffer to consumers additional financial services offered by the collaborating bank, including savings and investment opportunities, all of which may be based upon an agreement between the collaborating bank and the facilitator.

The bank may activate a credit or debit privilege on the consumer's consumer card, as disclosed for a card the merchant issued, or on a separate card linking to the membership card. Accordingly, in some embodiments, the bank may specify its data formats, interfaces, standards, and protocols applicable to the facilitator. The bank may report purchases by consumer card-carrying members at participating merchants to the facilitator frequently, for use in the facilitator's marketing plan and for the purpose of compensating the facilitator.

Specifically, with respect to analyzing creditworthiness of a consumer-applicant, the bank and the merchant's selling terminal or site, and a collaborating credit-card interchange venue may share information automatically or as necessary to approve or reject the credit or debit transaction by customary means. The bank or its data processor may also collects its customary card-issuer's percentage of transactions that are charged to the bank's credit or debit card, such as three percent, before remittances to the merchant. The bank may also bill the consumer periodically for purchases by credit card. The bank may include facilitator's advertising on the bill. The bank also may assess fees, increase rates, or discipline a consumer for abusing the card, all within consumer-friendly constraints the facilitator has negotiated with the bank.

In preferred embodiments, the bank delivers to the facilitator purchase transaction data verifying the consumer's purchases on a daily basis. The facilitator may, in turn, share anonymous and/or aggregated purchase data with the participating merchant, thereby providing a basis by which to evaluate the effect of specific advertising on the consumer's purchases. In addition, the report of consumer purchases, after targeted exposure to advertising, may serve as a way for the merchant to compensate facilitator; perhaps on commission.

The Role of the Merchant

In preferred embodiments, the merchant's first action in the foregoing process is to choose a product or service that it wishes to advertise to a class of consumers. The merchant may also create motivational benefits for consumer. In a non-limiting example, the benefits may include rewards or discounts (e.g., “two for the price of one,” etc.) to get consumer to enter the point of sale, purchase, and return to buy again.

The merchant may allow its name or logo to appear on the consumer cards. The merchant, and the merchant's advertising agency if merchant has one, along with the facilitator, and the facilitator's advertising agency if it has one, plan the advertising campaign and marketing plan jointly. Together they identify the goods or services and prices, and review sales from the preceding twelve months. The merchant or its agent may deliver graphic art, photography. The merchant may provide advertising messages to the facilitator in a standard, concise, digital format, such as GIF, JPEG, PDF, text, or in a word-processing document. The merchant may agree to compensate the facilitator on a negotiated schedule that is graduated according to sales during the campaign and for some acceptable period thereafter. Note that in some cases, the merchant might make no significant initial outlay for the marketing campaign.

While the facilitator expects, under some embodiments, to receive the majority of consumer purchase data from the participating bank or relevant payment processor, the merchant may, in some cases, issue relevant purchase transaction data, incorporating the consumer's identifying numbers and rate codes presented by the card-carrying members, to the facilitator in a mutually agreeable format and method. Moreover, the merchant may compensate the facilitator in relation to sales as negotiated above on a mutually agreeable schedule. The merchant may also pay the payment processor and the bank with the typical “interchange fee” as compensation for processing the payment.

What is claimed is:

1. A method for improving marketing practices for merchants and banks, the method comprising the steps of:
advertising a commercial offer to a consumer, wherein, said consumer is directed to a website for a facilitator;
collecting data from said consumer at said website, wherein said data contains said consumer's personally identifiable information and purchasing preferences and needs,
using said data to enable said facilitator to formulate a focused marketing plan based on said consumer's needs and preferences; and
compensating said facilitator based on purchases made by said consumer resulting from said facilitator's focused marketing plan.

2. The method of claim 1, wherein said step of collecting data is accomplished through use of a consumer card, applied for by said consumer, which identifies said consumer to said merchant.

3. The method of claim 2, wherein said consumer card may be selected from the group consisting of: a credit card, a debit card or a cash card.

4. The method of claim 1, further comprising the step of reporting said data to a facilitator, wherein said facilitator refers said data to a potentially-partnering bank so that said bank may extend said consumer a line of credit.

5. The method of claim 4, wherein upon said bank extending said consumer a line of credit, said consumer card then may serve as a payment card.

6. A system for improving marketing practices for merchants and banks comprising:
consumer card for use by a consumer to identify said consumer to a merchant when said consumer is making a purchase;
a merchant device that accepts said consumer card as either a method of payment from said consumer, or as a method of identification of said consumer;
a facilitator that offers said consumer card to said consumer so that said facilitator may track said consumer's purchasing history to understand said consumer's preferences, needs and spending behavior, and report said data collected from said consumer card to said merchant so that said merchant may formulate a focused marketing plan to market to said consumer

7. A system as in claim 6, further comprising said consumer card having payment capabilities extended to it by a collaborating bank.

8. A system as in claim 6, further comprising a compensation plan, wherein said facilitator is compensated based on purchases consumer makes resulting from said focused marketing plan.

9. The system of claim 6, wherein said consumer card may be selected from the group consisting of: a credit card, a debit card or a cash card.

10. The system of claim 6, wherein upon said bank extending said consumer a line of credit, said consumer card then may serve as a payment card.

11. A computer program product for implementing within a computer system a method for providing a customizable an in-store media broadcast at a remote location, the computer program product comprising:
a computer readable medium for providing computer program code means utilized to implement the method, wherein the computer program code means is comprised of executable code for implementing the steps for:
advertising a commercial offer to a consumer, wherein, said consumer is directed to a website for a facilitator;
collecting data from said consumer at said website, wherein said data contains said consumer's personally identifiable information and purchasing preferences and needs,
using said data to enable said facilitator to formulate a focused marketing plan based on said consumer's needs and preferences; and
compensating said facilitator based on purchases made by said consumer resulting from said facilitator's focused marketing plan.

12. A computer program product as recited in claim 11, wherein said step of collecting data is accomplished through use of a consumer card, applied for by said consumer, which identifies said consumer to said merchant.

13. A computer program product as recited in claim 11, wherein said consumer card may be selected from the group consisting of: a credit card, a debit card or a cash card.

14. A computer program product as recited in claim 11, further comprising the step of reporting said data to a facilitator, wherein said facilitator refers said data to a potentially-partnering bank so that said bank may extend said consumer a line of credit.

15. A computer program product as recited in claim 11, wherein upon said bank extending said consumer a line of credit, said consumer card then may serve as a payment card.
